(19) United States
(12) Patent Application Publication
(10) Pub. No.: US 2013/0328483 A1
(43) Pub. Date: Dec. 12, 2013

(54) MICROWAVE ICP RESONATOR

(71) Applicants: Roland Gesche, Seligenstadt (DE); Horia-Eugen Porteanu, Berlin (DE); Silvio Kühn, Wandlitz (DE)

(72) Inventors: Roland Gesche, Seligenstadt (DE); Horia-Eugen Porteanu, Berlin (DE); Silvio Kühn, Wandlitz (DE)

(73) Assignee: Forschungsverbund Berlin E.V., Berlin (DE)

(21) Appl. No.: 13/884,973

(22) PCT Filed: Nov. 15, 2011
(86) PCT No.: PCT/EP2011/070128

§ 371 Date: Jul. 2, 2013

(30) Foreign Application Priority Data
Nov. 15, 2010 (DE) 102010043940.1

(51) Int. Cl. H05H 1/46

(52) U.S. Cl. CPC H05H 1/46
USPC 315/111.51

(57) ABSTRACT

A microwave resonator for inductively generating a plasma (5) is introduced. The microwave resonator comprises a first tube (4) and a conductive, preferably metal, plate (1). The tube (4) is designed for connection to a supply device for a process gas and for conveying the process gas and comprises a dielectric material. The conductive plate (1) has a first, preferably cylindrical, hole (2), which extends from a first opening on a first side of the conductive plate (1) to a second opening on a second side, opposite the first side, of the conductive plate (1). The first tube (4) is arranged in the first hole (2). The conductive plate (1) also has a first slit (3), which is open towards the first and the second side of the conductive plate (1) and towards the first hole (2).

The invention also introduces a plasma generator with such a microwave resonator.

### TECHNICAL FIELD

The invention relates to a microwave resonator for inductively generating a plasma and a plasma generator with such a microwave resonator.

### STATE OF THE ART

In the state of the art, numerous methods for generating a plasma from a process gas are known. Likewise, numerous potential uses for a plasma are known. For example, a plasma generator as described in the invention can be used to treat surfaces in case of coating by means of Plasma Enhanced Chemical Vapour Deposition (PECVD), Atomic Layer Deposition (ALD) or sputtering, for plasma etching, to clean process chambers or activate surfaces. It can also be used in medicine, such as for skin treatment or sterilization. Furthermore, plasma generators can be used in material and process analysis.

It is known to generate a plasma by passing a process gas through a tube that is dielectric at least in sections, wherein the process gas is capacitively excited in the tube. The conductive electrode(s) is/are located outside the tube and, as a result, are not in direct contact with the plasma. The inner diameter of such a tube usually ranges between 1 mm and a few centimetres. In case of capacitive coupling, the capacitance of the dielectric wall of the tube is a major disadvantage due to the voltage drop occurring there.

### SUMMARY OF THE INVENTION

The invention therefore introduces a microwave resonator for inductively generating a plasma, where inductive excitation of the process gas avoids the aforesaid drawback. The microwave resonator comprises a first tube, which is designed for connection to a supply device for a process gas and for conveying the process gas and comprises a dielectric material. According to the invention, a conductive, preferably metal, plate is provided, which has a first, preferably cylindrical, hole and a first slit. The first hole extends from a first opening on a first side of the conductive plate to a second opening on a second side, opposite the first side, of the conductive plate. The first tube (or a section of the first tube comprising the dielectric material) is arranged in the first hole. The first slit is open towards the first and the second side of the conductive plate and towards the first hole.

As a result of the structure according to the invention, a resonator is obtained where the inner wall of the first hole forms the antenna for inductively coupling microwave energy into the process gas in order to generate a plasma. This means the current density on the inner wall of the first hole generates the magnetic field which causes excitation of the plasma. The first hole thus constitutes at least part of the inductance of the microwave resonator. The first slit forms the corresponding capacitance. All or part of the first slit can be filled with a dielectric material, as can be all other slits in the other exemplary embodiments of the invention.

A resonance frequency of the microwave resonator ranges preferably between 2 and 3 GHz; particularly preferred, it is 2.45 GHz.

The invention provides an excitation structure which enables efficient inductive plasma excitation (ICP) at microwave frequencies. In this way, the advantages of

ICP technology are combined with those of microwave plasmas. The inductive coupling of the magnetic fields enables the microwave energy to be favourably coupled into the process gas through the wall of the dielectric tube, thus avoiding the losses caused by the dielectric in case of capacitive coupling.

For the purpose of the invention, “plate” refers to a body whose dimensions along two spatial axes are much larger, preferably at least five times, but even better ten times, than that along the remaining spatial axis.

The first slit can in addition be open towards a first edge surface of the conductive plate. In this embodiment, a plurality of pairs of first holes and first slits can also be provided in order to increase the amount of plasma that can be generated during a defined period of time. This principle can of course be applied to all other exemplary embodiments as well.

The microwave resonator can also have a second, preferably also cylindrical, hole, which extends from a third opening on the first side of the conductive plate to a fourth opening on the second side of the conductive plate. In this alternative embodiment, the first slit is open towards the second hole. As a result, the first slit terminates in a hole at both its ends. Of course, several such pairs of holes connected by a slit can be provided in order to increase the plasma volume. This embodiment has the advantage that the conductive plate can be connected to ground on its entire circumferential surface.

Preferably, this embodiment of the microwave resonator according to the invention is provided with a second tube, which is also designed for connection to the supply device for the process gas and for conveying the process gas. The second tube is arranged in the second hole and also comprises a dielectric material.

The microwave resonator can also have a third tube, a fourth tube, a third, preferably cylindrical, hole and a fourth, also preferably cylindrical, hole. In this case, the third and the fourth tube are designed for connection to the supply device for the process gas and for conveying the process gas and comprise a dielectric material. The third and the fourth hole extend from a fifth opening on the first side of the conductive plate to a sixth opening on the second side of the conductive plate and from a seventh opening on the first side of the conductive plate to an eighth opening on the second side of the conductive plate respectively. The third tube and the fourth tube are arranged in the third hole and in the fourth hole respectively.

In this case, the microwave resonator preferably has a second slit, which is open towards the first and the second side of the conductive plate and towards the third and the fourth hole. All or part of the second slit can also be filled with a dielectric.

In an advantageous embodiment, the first and the second slit intersect, preferably at an at least approximately right angle.

In this case, the microwave resonator can have a rectangular, preferably square, or elliptic, preferably circular, opening, which is open towards the first and the second side of the conductive plate and arranged in an area where the first and the second slit intersect.

The microwave resonator can be provided with a contact to ground arranged on a second edge surface of the conductive plate. In embodiments where none of the slits is open towards an edge surface of the microwave resonator, the entire edge surface can be provided with a contact to ground.

A second aspect of the invention introduces a plasma generator with a microwave resonator according to the first aspect of the invention. The plasma generator is provided with at least one supply device for a process gas that is connected to the microwave resonator, and an excitation device for exciting the microwave resonator.

The plasma generator according to the invention can be used for all known plasma methods, in the low-pressure range as well as at atmospheric pressure. The fact that the plasma is excited without electrodes enables inert gases as well as reactive gases and mixtures thereof to be used.

Particularly preferred, the excitation device comprises an active switching element, so that the excitation device and the microwave resonator constitute an oscillator. The amplifier “de-dampens” the microwave resonator, thus forming a “free-running” oscillator.

As an alternative, the plasma generator can also be provided with an excitation device configured as a microwave generator which is designed to generate a microwave signal and output it to the microwave resonator. In this case, the microwave resonator functions as a part of impedance matching. The microwave generator can for example be a magnetron or a signal generator including a power amplifier.

The plasma generator can be provided with a conductive cavity which houses the microwave resonator. In this case, the microwave generator is connected to the conductive cavity and designed to supply microwave energy into the conductive cavity.

However, there are many different alternative ways to couple the microwave resonator, for example magnetically by means of a conductor loop placed around the first hole, for example above the conductive plate. As an alternative, a capacitive coupling can be arranged on opposite sides of the first slit. Galvanic coupling can be achieved through contact points on the first side of the conductive plate of the microwave resonator or by means of waveguide structures.

### SHORT DESCRIPTION OF THE FIGURES

The invention will now be described in more detail with reference to illustrations of exemplary embodiments, in which:

FIG. 1 shows a first exemplary embodiment of the invention;

FIG. 2 shows a second exemplary embodiment of the invention; and

FIG. 3 shows a third exemplary embodiment of the invention.

### EXEMPLARY EMBODIMENTS OF THE INVENTION

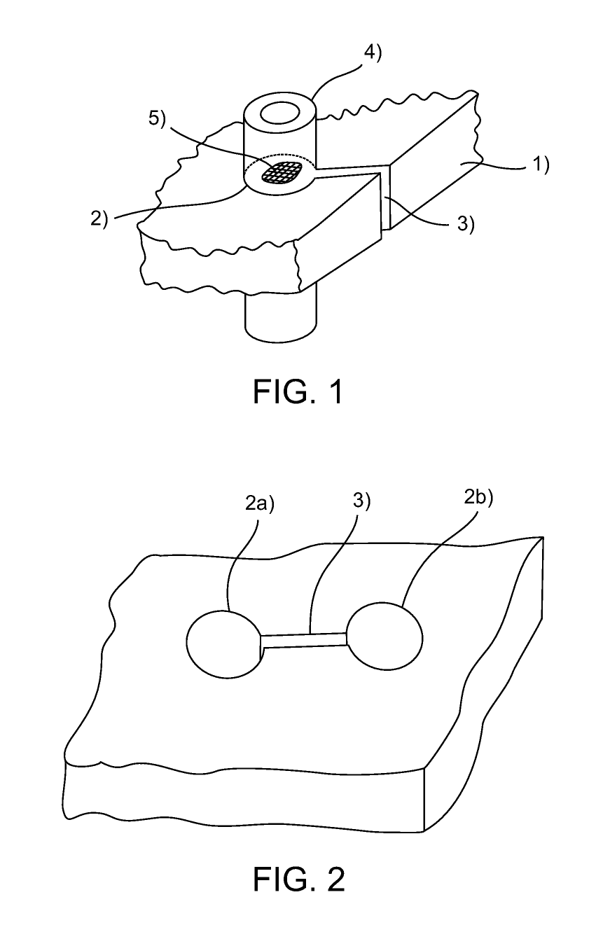

FIG. 1 shows a first exemplary embodiment of the invention. A conductive, preferably metal, plate 1 comprises a hole 2, which serves as an inductive coupling loop to a plasma 5 and in which a tube 4 made of a dielectric material is arranged to convey the process gas. The conductive plate can, in principle, be of any desired size and connected to ground at almost any position, which e.g. facilitates cooling. A slit 3 in the conductive plate forms a capacitance, which together with the inductance of the hole forms a resonance circuit. The process gas is excited in the area of the hole 2, thus generating the plasma 5 in said area. In the exemplary embodiment of FIG. 1, the slit 3 is open towards a (narrow) end surface of the conductive plate 1. All or part of it can for example be filled with a dielectric, thus advantageously achieving a spatial separation between a compartment of a process chamber on one side of the conductive plate 1 and the surroundings.

FIG. 2 shows a second exemplary embodiment of the invention. In this exemplary embodiment, two holes 2a and 2b are provided, which are connected by the slit 3. Again, all or part of the slit 3 can be filled with a dielectric. One or two tube(s) for the process gas can be provided in this embodiment of the invention. The advantage of this exemplary embodiment is that the base plate can be connected to ground along its entire periphery since the slit 3 is not open towards a narrow side of the conductive plate 1, which facilitates structural design.

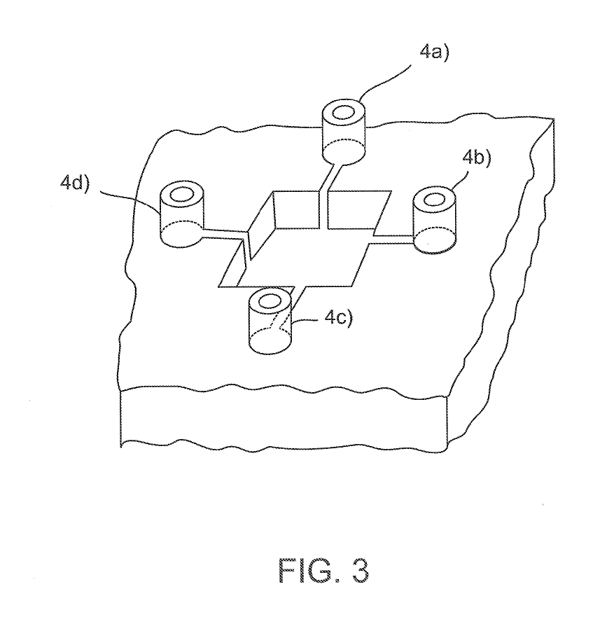

FIG. 3 shows a third exemplary embodiment of the invention. The third exemplary embodiment illustrates an assembly including four plasma areas, each of which comprises a hole and a tube 4a to 4d arranged in the hole. A slit connects each of the holes to a square opening in the area where the slits intersect. This concept can be implemented with any desired number of plasma areas (for example as star-shaped assemblies with plasma areas at the tips of the points of the star, which are configured as slits, and an optional central opening in the form of a polygon whose number of sides matches the number of points or in the form of a circle); furthermore, these structures of the structure of FIG. 2 can be placed next to each other in any desired manner or combined with the structures of the other exemplary embodiments.

Excitation of the microwave resonator according to the invention can, in general, be achieved according to two principles:

1.) The microwave resonator functions as a resonator which is de-dampened by means of a connected circuit, thus forming a “free-running” oscillator.

2.) An external microwave generator is used, e.g. a magnetron or a signal generator including a power amplifier. In this case, the microwave resonator can be used as a part of impedance matching.

The microwave resonator can for example be coupled magnetically, capacitively or galvanically or by means of waveguide structures. Magnetic coupling can e.g. be achieved by means of a conductor loop placed around the hole 2 above the conductive plate 1. Galvanic coupling through contact points on the surface of the conductive plate 1 near the hole 2 or the slit 3 is also possible. A capacitive coupling can for example be arranged on the end surface of the plate 1 on both sides of the slit 3. Another option is to arrange a source including one or more resonator(s) in a conductive cavity into which microwave energy is supplied, e.g. from a magnetron in the way of a microwave oven.

1. A microwave resonator for inductively generating a plasma, which microwave resonator comprises a first tube, which is designed for connection to a supply device for a process gas and for conveying the process gas and comprises a dielectric material, wherein a conductive, preferably metal, plate, which has a first, preferably cylindrical, hole, which extends from a first opening on a first side of the conductive plate to a second opening on a second side, opposite the first side, of the conductive plate and in which the first tube is arranged, and a first slit, wherein the first slit is open towards the first and the second side of the conductive plate and towards the first hole.

2. The microwave resonator according to claim 1, wherein the first slit is also open towards a first edge surface of the conductive plate.

3. The microwave resonator according to claim 1, including a second, preferably cylindrical, hole, which extends from a third opening on the first side of the conductive plate to a fourth opening on the second side of the conductive plate, wherein the first slit is open towards the second hole.

4. The microwave resonator according to claim 3, including a second tube, which is designed for connection to the supply device for the process gas and for conveying the process gas and is arranged in the second hole and comprises a dielectric material.

5. The microwave resonator according to claim 4, including a third tube, a fourth tube, a third, preferably cylindrical, hole and a fourth, preferably cylindrical, hole, wherein the third and the fourth tube are designed for connection to the supply device for the process gas and for conveying the process gas and comprise a dielectric material, wherein the third and the fourth hole extend from a fifth opening on the first side of the conductive plate to a sixth opening on the second side of the conductive plate and from a seventh opening on the first side of the conductive plate to an eighth opening on the second side of the conductive plate respectively, and wherein the third tube and the fourth tube are arranged in the third hole and the fourth hole respectively.

6. The microwave resonator according to claim 5, including a second slit, which is open towards the first and the second side of the conductive plate and towards the third and the fourth hole.

7. The microwave resonator according to claim 6, wherein the first and the second slit intersect.

8. The microwave resonator according to claim 7, wherein the first and the second slit intersect at an at least approximately right angle.

9. The microwave resonator according to claim 7, including a rectangular, preferably square, or elliptic, preferably circular, opening, which is open towards the first and the second side of the conductive plate and arranged in an area where the first and the second slit intersect.

10. The microwave resonator according to claim 1, including a contact to ground arranged on a second edge surface of the conductive plate.

11. A plasma generator with a microwave resonator according to claims 1, a supply device for a process gas that is connected to the microwave resonator, and an excitation device for exciting the microwave resonator.

12. The plasma generator according to claim 11, wherein the excitation device comprises an active switching element, so that the excitation device and the microwave resonator constitute an oscillator.

13. The plasma generator according to claim 11, wherein the excitation device comprises a microwave generator which is designed to generate a microwave signal and output it to the microwave resonator.

14. The plasma generator according to claim 13, including a conductive cavity which houses the microwave resonator, wherein the microwave generator is connected to the conductive cavity and designed to supply microwave energy into the conductive cavity.

15. The plasma generator according to claim 11, wherein the microwave resonator is coupled magnetically by means of a conductor loop placed around the first hole, by means of a capacitive coupling arranged on opposite sides of the first slit, galvanically through contact points on the first side of the conductive plate of the microwave resonator or by means of waveguide structures.
